(19) United States
(12) Patent Application Publication
(10) Pub. No.: US 2014/0342148 A1
(43) Pub. Date: Nov. 20, 2014

(54) GLASS STRUCTURES AND METHODS OF CREATING AND PROCESSING GLASS STRUCTURES

(71) Applicant: CORNING INCORPORATED, Corning, NY (US)

(72) Inventors: Dana Craig Bookbinder, Corning, NY (US); Gary Stephen Calabrese, Corning, NY (US); Theresa Chang, Painted Post, NY (US); Sean Matthew Garner, Elmira, NY (US); Robert Randall Hancock, JR., Corning, NY (US); Jennifer Lynn Lyon, Painted Post, NY (US)

(73) Assignee: CORNING INCORPORATED, Corning, NY (US)

(21) Appl. No.: 13/894,999

(22) Filed: May 15, 2013

(51) Int. Cl. B32B 17/10; B32B 37/02

(52) U.S. Cl. CPC B32B 17/10036; B32B 37/02; B32B 2307/40; B32B 2457/20
USPC 428/336; 428/426; 428/435; 428/337; 156/60; 156/310

(57) ABSTRACT

A glass structure and a method for creating the glass structure include a glass carrier layer and a flexible glass substrate. The glass structure includes an intermediate layer at least temporarily bonding the flexible glass substrate to the glass carrier layer. The intermediate layer includes a first debond layer attached to an adhesion layer. The first debond layer is at least partially resistant to a high temperature processing of the glass structure at a temperature of greater than or equal to about 500° C. The first debond layer is configured to enable the flexible glass substrate to be debonded from the glass carrier layer after the high temperature processing of the glass structure. A method for processing the glass structure includes debonding the flexible glass substrate from the glass carrier layer after the high temperature process.

The present disclosure relates generally to glass structures and methods of creating and processing glass structures and, more particularly, to glass structures and methods including temporarily bonding a flexible glass substrate to a glass carrier layer using an intermediate layer compatible with high temperature glass processing while retaining the ability to debond the flexible glass substrate from the glass carrier layer after the high temperature glass processing.

### BACKGROUND

Increasing demands for relatively thin display applications has led glass display manufacturers to process thinner glass substrates. However, these thinner glass substrates exhibit decreased stiffness which typically produces problems when attempting to process such flexible glass substrates with existing glass substrate process machinery that is designed to process relatively thick glass substrates. As a result, many glass substrates are produced as relatively thick glass substrates which are subsequently etched and/or polished to a thinner dimension. This leads to increased waste, increased production cost, and increased defect rates in the glass substrates. In alternative examples, carrier layers can be bonded to the glass substrate to provide stiffness to the glass substrate enabling the flexible glass substrate and display applications to be manufactured on standard process machinery. However, such carrier layers typically employ a bonding agent that may not be compatible with high temperature processing techniques. Indeed, existing bonding agents may break down under typical processing temperatures, thereby damaging associated electronic components, eliminating stiffness benefits of the glass carrier, and/or promoting outgassing of damaging gasses.

### SUMMARY

In a first aspect, a glass structure includes a glass carrier layer and a flexible glass substrate. The glass structure further includes an intermediate layer at least temporarily bonding the flexible glass substrate to the glass carrier layer. The intermediate layer includes a first debond layer attached to an adhesion layer. The first debond layer is at least partially resistant to a high temperature processing of the glass structure at a temperature of greater than or equal to about 300° C., greater than or equal to about 400° C. and even greater than or equal to about 500° C. The first debond layer is configured to enable the flexible glass substrate to be debonded from the glass carrier layer after the high temperature processing of the glass structure.

In one example of the first aspect, the first debond layer includes a polyimide.

In another example of the first aspect, an average thickness of the intermediate layer is less than about 20 microns.

In yet another example of the first aspect, the glass carrier layer is attached to the first debond layer and the flexible glass substrate is attached to the adhesion layer.

In still yet another example of the first aspect, the flexible glass substrate is attached to the first debond layer and the adhesion layer is located between the glass carrier layer and the first debond layer.

In another example of the first aspect, the glass structure further includes a second debond layer located between the adhesion layer and the glass carrier layer.

In yet another example of the first aspect, the flexible glass substrate includes an average thickness of less than about 300 microns.

In still yet another example of the first aspect, an average thickness of the glass carrier layer is within a range of from about 300 microns to about 700 microns.

The first aspect may be carried out alone or with one or any combination of the examples of the first aspect discussed above.

In a second aspect, a method of creating a glass structure includes the step (I) of providing a glass carrier layer. The method further includes the step (II) of providing a flexible glass substrate. The method still further includes the step (III) of temporarily bonding the glass carrier layer to the flexible glass substrate with an intermediate layer comprising a first debond layer and an adhesion layer. The first debond layer is at least partially resistant to a high temperature processing of the glass structure at a temperature of greater than or equal to about 500° C. The first debond layer enables the glass carrier layer to be debonded from the flexible glass substrate after the high temperature processing of the glass structure.

In one example of the second aspect, step (III) further includes the step of applying the first debond layer on a surface of at least one of the glass carrier layer and the flexible glass substrate.

In another example of the second aspect, step (III) further includes at least partially curing the first debond layer.

In yet another example of the second aspect, after at least partially curing the first debond layer, step (III) further includes the step of applying the adhesion layer to a surface of the first debond layer.

In still yet another example of the second aspect, step (III) further includes the step of applying a second debond layer to the other of the glass carrier and the flexible glass substrate.

In another example of the second aspect, step (III) includes applying the adhesion layer to the surface of the first debond layer prior to the step of applying the second debond layer to the other of the glass carrier layer and the flexible glass substrate.

In yet another example of the second aspect, the method further includes the step of curing the first debond layer to a polyimide layer.

In still yet another example of the second aspect, step (III) temporarily bonds the glass carrier layer with the first debond layer.

In another example of the second aspect, step (III) temporarily bonds the flexible glass substrate with the first debond layer.

The second aspect may be carried out alone or with one or any combination of the examples of the second aspect discussed above.

In a third aspect, a method of processing a glass structure includes the step (I) of providing a glass structure. The glass structure includes a glass carrier layer, a flexible glass substrate, and an intermediate layer attaching the flexible glass substrate to the glass carrier layer. The intermediate layer includes a first debond layer attached to an adhesion layer. The method further includes the step (II) of processing the glass structure through a high temperature process at a temperature of greater than or equal to about 500° C. Then, the method still further includes the step (III) of de-bonding the flexible glass substrate from the glass carrier layer.

In one example of the third aspect, step (II) of processing the glass structure includes attaching at least one electrical component to the glass structure.

In another example of the third aspect, after the step (III) of debonding the flexible glass substrate from the glass carrier layer, a portion of the intermediate layer remains attached to the flexible glass substrate.

The third aspect may be carried out alone or with one or any combination of the examples of the third aspect discussed above.

### BRIEF DESCRIPTION OF THE DRAWINGS

The above and other features, aspects and advantages of the present invention are better understood when the following detailed description of the invention is read with reference to the accompanying drawings, in which:

FIG. 1 is a schematized perspective view of an example glass structure showing a first debond layer bonded to a glass carrier layer;

FIG. 2 is another example glass structure similar to FIG. 1, but showing the first debond layer bonded to a flexible glass substrate;

FIG. 3 is yet another example glass structure similar to FIG. 2, but also showing a second debond layer bonded to the glass carrier layer;

FIG. 4 is a schematized view of an example method of creating a glass structure and processing the glass structure;

FIG. 5 is a schematized side view illustrating a method step of debonding the flexible glass substrate from a transparent glass carrier layer of the example glass structure of FIG. 1 using a laser beam passing through the glass carrier layer;

FIG. 6 is a schematized side view of the debonded glass structure of FIG. 5;

FIG. 7 is a schematized side view illustrating a method step of debonding a transparent flexible glass substrate from the glass carrier layer including the example glass structure of FIG. 1 using a laser beam passing through the transparent flexible glass substrate and a transparent adhesion layer;

FIG. 8 is a schematized side view of the debonded glass structure of FIG. 7;

FIG. 9 is a schematized side view illustrating a method step of debonding the flexible glass substrate from a transparent glass carrier layer including the example glass structure of FIG. 2 using a laser beam passing through the transparent glass carrier layer and a transparent adhesion layer;

FIG. 10 is a schematized side view of the debonded glass structure of FIG. 9;

FIG. 11 is a schematized side view illustrating a method step of debonding a transparent flexible glass substrate from the glass carrier layer including the example glass structure of FIG. 2 using a laser beam passing through the transparent flexible glass substrate; and

FIG. 12 is a schematized side view of the debonded glass structure of FIG. 11.

### DETAILED DESCRIPTION

The present invention will now be described more fully hereinafter with reference to the accompanying drawings in which example embodiments of the claimed invention are shown. Whenever possible, the same reference numerals are used throughout the drawings to refer to the same or like parts. However, the claimed invention may be embodied in many different forms and should not be construed as limited to the embodiments set forth herein. These example embodiments are provided so that this disclosure will be both thorough and complete, and will fully convey the scope of the claimed invention to those skilled in the art.

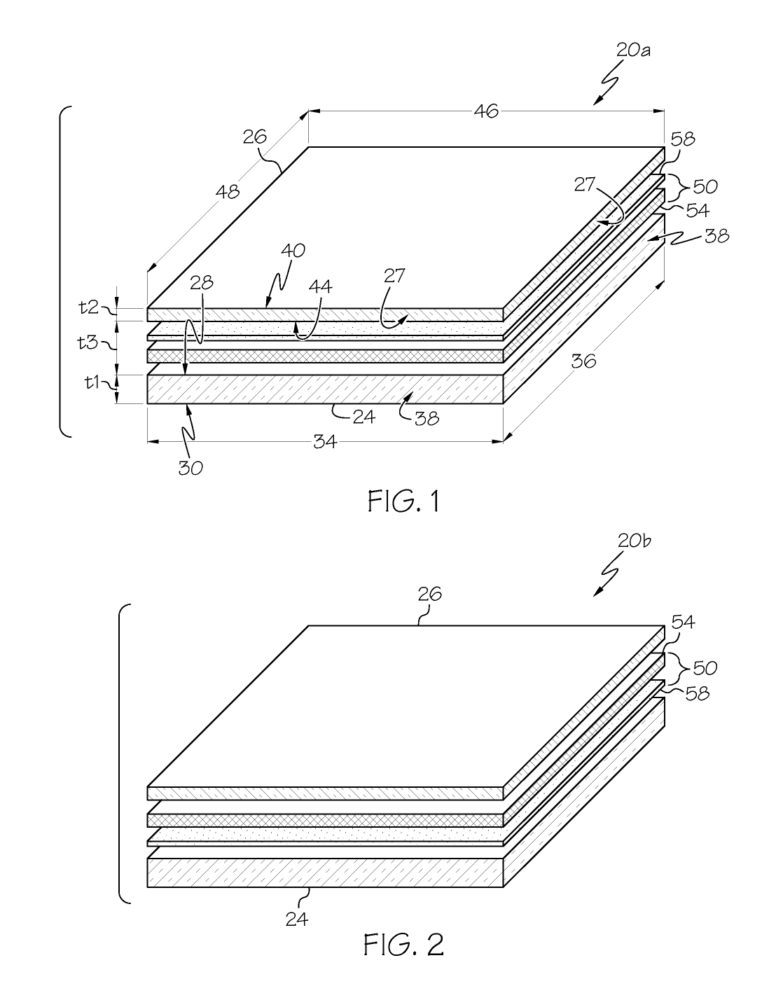

Demand for increasingly thinner glass electronic displays that may be fabricated with various methods such as down-drawn, up-draw, float, fusion, press rolling, or slot draw glass forming processes or other techniques. Glass sheets sub-divided from glass substrates are commonly used, for example, in display applications, for example liquid crystal displays (LCDs), electrophoretic displays (EPD), organic light emitting diode displays (OLEDs), plasma display panels (PDPs), or the like. In some applications, glass substrates are processed to add electrical components in order to manufacture glass electronic displays. In one particular example, flexible glass substrates are utilized in a number of applications, such as touch sensors, color-filters, thin film transistors (TFT), and photovoltaic (PV) glass applications. The flexible glass substrate discussed herein may, for example, be a glass ribbon of indeterminate length, or a portion of a glass ribbon (e.g., a separated portion comprising a glass sheet). The flexible glass substrate for these applications can comprise a flexible substrate with a thickness of less than or equal to about 0.3 millimeters (mm). This flexible glass can be processed as a sheet of glass substrate or as a ribbon of glass. Although flexible glass substrate can be processed on a roll-to-roll basis, further examples include providing thin sheets of glass substrate as illustrated in FIG. 1. As with the remaining figures in the drawings, FIG. 1 is illustrated in schematic form wherein the features shown in the drawings are not necessarily in proportion.

As shown in FIG. 1, a glass structure 20a includes a glass carrier layer 24 that is configured to provide support for a flexible glass substrate 26 while processing the glass structure 20a. The glass carrier layer 24 may include an average thickness “t1” defined between a first major surface 28 and a second major surface 30 facing away from the first major surface 28. In one example, the average thickness t1 of the glass carrier layer 24 is within a range of from about 300 microns to about 1000 microns, such as from about 300 microns to about 700 microns, although other thicknesses may be provided in further examples.

The glass carrier layer 24 can include a length dimension 34 and a width dimension 36. While any suitable combinations of glass carrier layer dimensions 34, 36 can be provided, it may be beneficial to provide a glass carrier layer 24 having dimensions 34, 36 which are appropriate for the end device that will incorporate the flexible glass substrate 26. In one example, the glass carrier layer 24 can have dimensions 34, 36 which correspond to sizes typically used in glass substrate display manufacturing. For example, the glass carrier layer 24 can optionally have dimensions 34, 36 from about 370 mm by 470 mm (approximately 14.6 inches (in) by 18.5 in) up to about 2,880 mm by 3,130 mm (approximately 113.4 in by 123.2 in).

The glass carrier layer 24 can optionally be machined and/or cleaned prior to assembly with other components of the glass structure 20a. In one example, the glass carrier layer 24 can include edges 38 that are edge finished. Edge machining and/or cleaning can improve the glass handling characteristics for the glass structure 20a. Additionally, it can be beneficial for the glass carrier layer 24 to include a composition that is compatible with the processing steps that create the desired display application using the glass structure 20a. In one example, the glass carrier layer 24 can comprise an alkali-free composition, for instance, when a silicon TFT processing step is used to create the desired display application.

The glass structure 20a also includes the flexible glass substrate 26 which will form a portion of the display or electronic device application. The flexible glass substrate 26 can include an average thickness “t2” defined between a first major surface 40 and a second major surface 44 facing away from the first major surface 40. In some examples, the flexible glass substrate 26 can include an average thickness t2 of less than or equal to about 300 microns. In a further example, the flexible glass substrate 26 can include an average thickness t2 of less than or equal to about 200 microns, such as less than or equal to about 100 microns, less than or equal to about 50 microns. Typically, an average thickness t2 of the glass substrate 26 will be greater than or equal to 10 microns. Accordingly, suitable ranges for average thickness include 10 μm≦t2≦300 μm, 10 μm≦t2≦200 μm, 10 μm≦t2≦100 μm, 10 μm≦t2≦500 μm. The average thickness t2 of the flexible glass substrate 26 is typically determined by the desired display application.

Similar to the glass carrier layer 24 composition as described above, it can be beneficial for the composition of the flexible glass substrate 26 to be compatible with the processing steps that create the desired display or electronic device application using the glass structure 20a. In one example, the flexible glass substrate 26 should include an alkali-free composition when a silicon TFT processing step is used to create the desired display application. It can also be beneficial for the composition of the flexible glass substrate 26 to be similar to the composition of the glass carrier layer 24 so that the two glass components have the same or substantially similar coefficients of thermal expansion (CTE). Substantially similar CTE can be provided with a difference between the CTE being less than or equal to 20×10⁻⁷ cm/cm/° C., such as less than or equal to 10×10⁻⁷ cm/cm/° C., such as less than or equal to 5×10⁻⁷ cm/cm/° C., such as less than or equal to about 1×10⁻⁷ cm/cm/° C. Providing the flexible glass substrate and the glass carrier layer with substantially similar or the same CET can reduce and/or eliminate undesired thermal stresses and thermal strains arising from different expansion and contraction rates within the flexible glass substrate 26 and the glass carrier layer 24 as the glass structure 20a is exposed to thermal cycling (e.g., in a relatively high-temperature electronic component deposition process).

Similar to the glass carrier layer 24, the flexible glass substrate 26 can include a length dimension 46 and a width dimension 48. The dimensions 46, 48 can be equal to or less than the length dimension 34 and the width dimension 36 of the glass carrier layer 24. The described lesser dimensions 46, 48 of the glass substrate 26 can help reduce and/or eliminate edge impact damage to the flexible glass substrate 26 that can occur during routine handling of the glass structure 20a. Reduction and/or elimination of edge impact damage helps to maintain the structural integrity and endurance of the flexible glass substrate 26 and, thus, the display or electronic device application created with the flexible glass substrate 26. Damage reduction can be achieved, for example, by providing the flexible glass substrate 26 with dimensions 46, 48 equal to or less than the dimensions 34, 36. As such, relatively delicate edges 27 of the flexible glass substrate 26 can be guarded from damage due to various edge impacts that may be experienced by the glass structure. Such edge impacts would likely be absorbed by the edges 38 of the glass carrier layer 24 rather than the edges 27 of the flexible glass substrate 26 since the oversized glass carrier layer would have edges that are relatively more vulnerable to impact since these edges of the oversized glass carrier layer may protrude beyond the corresponding edges of the flexible glass substrate.

The glass structure 20a also includes an intermediate layer 50. The intermediate layer 50 is located between the glass carrier layer 24 and the flexible glass substrate 26 and at least temporarily bonds the flexible glass substrate 26 to the glass carrier layer 24. The intermediate layer 50 includes a first debond layer 54 which is attached to at least one of the glass carrier layer 24 and the flexible glass substrate 26. In one example, the attachment between the first debond layer 54 and at least one of the glass components 24, 26 is a temporary attachment that can be removed as will be described below. As shown in the example glass structure 20a of FIG. 1, the first debond layer 54 can be attached to the glass carrier layer 24.

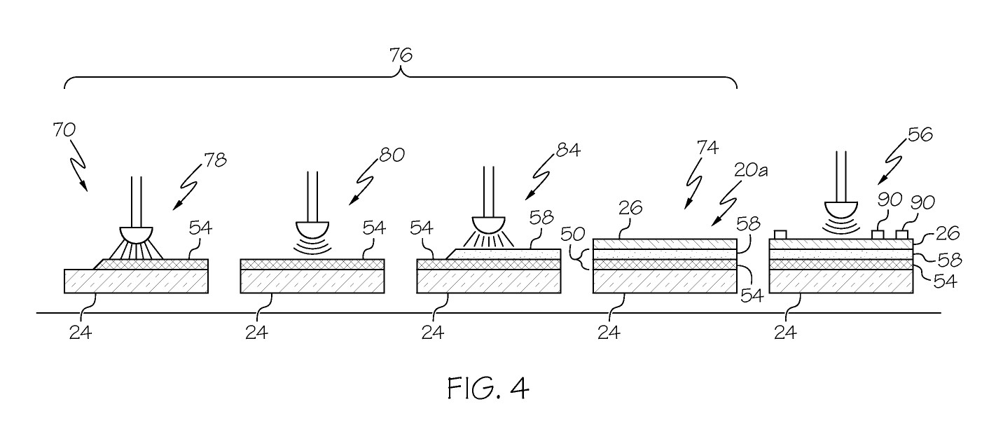

Composition of the first debond layer 54 can be compatible with fabrication conditions as the glass structure 20 is processed. In this context, the term “process” and other derivations of the word process can include any step subsequent to the formation of the flexible glass substrate 26, including but not limited to the deposition of additional layers and/or components (e.g. electrical/electronic components or portions thereof) on the flexible glass substrate 26. For example, the term processed can include a high temperature process 56, schematically shown in FIG. 4. For example, the attachment of electrical components and/or formation of thin film devices (e.g. transistors, electroluminescent layers, etc.) on the flexible glass substrate 26 may require the high temperature process 56. The first debond layer 54 is at least partially resistant to the high temperature processing 56 of the glass structure 20a at a temperature of greater than or equal to about 500° C., such as from about 500° C. to about 600° C. The first debond layer 54 can also be at least partially resistant to lower temperature processing such as temperatures of 400° C. or less, such as 300° C. or less. In one example, the described first debond layer 54 partial resistance to the high temperature process 56 can include properties such as no substantial reduction in bond strength that the first debond layer 54 is able to maintain after exposure to the high temperature process 56.

In another example, properties of the first debond layer 54 minimize and/or eliminate degradation of the first debond layer 54 leading to outgassing when exposed to relatively high temperatures which can negatively affect the process of electronic component deposition on the flexible glass substrate 26. Additionally, the first debond layer 54 is configured to enable the flexible glass substrate 26 to be debonded from the glass carrier layer 24 after the high temperature processing 56 of the glass structure 20a. In one example, the first debond layer 54 is debondable using a laser release method as will be further described below.

In one example, the first debond layer 54 comprises a polyimide. Some polyimides include the features of being compatible with fabrication conditions as the glass structure 20a is processed, exhibit minimal outgassing at relatively high temperatures, and enable debonding after high temperature processing as described above. In one example, the polyimide can be a liquid material which can be applied in relatively thin layers. One particular example of polyimide suitable for the described glass structure 20a includes the polyimide material known as PI-2574 sold by HD Microsystems. Further examples of polyimide suitable for the described glass structure 20a include the material sold under the trademark KAPTON (KAPTON is a registered trademark of E.I. DuPont de Nemours and Company Corporation); the material sold under the trademark MATRIMID 5218 (MATRIMID is a registered trademark of Ciba-Geigy Corporation); and the materials known as PI-2611, PI-2525, and HD-3007, each sold by HD Microsystems.

In another example, the first debond layer can comprise an all aromatic polyetherketone or all aromatic polyester.

Returning to FIG. 1, the intermediate layer 50 includes the first debond layer 54 attached to an adhesion layer 58. The first debond layer 54, together with the adhesion layer 58, form the intermediate layer 50 which at least temporarily bonds the flexible glass substrate 26 to the glass carrier layer 24. The adhesion layer 58 includes adhesion properties that enable the adhesion layer 58 to bond together layers of material on either side of the adhesion layer. Similar to the first debond layer 54, the adhesion layer 58 composition can be compatible with fabrication conditions as the glass structure 20a is processed. In one example, the adhesion layer 58 can withstand the high temperature processing 56 of the glass structure 20a at a temperature of greater than or equal to about 500° C., such as from about 500° C. to about 600° C., to maintain its adhesive properties.

In another example, properties of the adhesion layer 58 minimize and/or eliminate degradation of the adhesion layer 58 leading to outgassing of organic products when exposed to relatively high temperatures. Outgassing products such as cyclic low molecular weight siloxanes can negatively affect the process of electronic component deposition on the flexible glass substrate 26, and, as such, it can be beneficial to limit outgassing from the adhesion layer 58 in order to minimize and/or eliminate the negative effects on the electrical component deposition process.

It can be beneficial for the adhesion layer 58 to include similar properties as the above-described first debond layer 54. Namely, the adhesion layer 58 can include the features of being compatible with fabrication conditions as the glass structure 20a is processed, maintain a level of adhesion after exposure to the high temperature process 56, and exhibit minimal outgassing at relatively high temperatures. In one example, the adhesion layer material can be a liquid material which can be applied in relatively thin layers. A number of examples of materials suitable for use as the adhesion layer 58 include, but are not limited to, materials sold under the trademarks DOW CORNING 805, DOW CORNING 806A, DOW CORNING 840 (DOW CORNING is a registered trademark of Dow Corning Corporation); silicon resins, 3-aminopropyltriethoxysilane (GAPS); and aminopropylsilsesquioxane (APS), meta or para aminopheryl trimethoxysilcane or aminopherylsilsesanaxane. In further examples, a number of the above listed materials suitable for the first debond layer 54 can also be suitable for use in the adhesion layer 58.

In addition to the properties of the first debond layer 54 and the adhesion layer 58 limiting the quantities of outgassing during further processing of the glass structure 20a, an average thickness t3 of the intermediate layer 50 can be limited to help accomplish the same goal. As can be appreciated, limiting the amount of organic materials such as those listed as suitable for use in the first debond layer 54 and the adhesion layer 58 will also limit the amount of outgassing during processes that can include high temperature exposure, and TFT vacuum processing. In one example, the intermediate layer 50 can include an average thickness t3 in a range from about 0.05 μm to about 20 μm, such as less than or equal to about 20 μm, such as less than or equal to about 10 μm, such less than or equal to about 5 μm, such as less than or equal to about 1 μm, such as less than or equal to about 0.1 μm. Several factors can determine the minimum average thickness of the intermediate layer 50 including, but not limited to, the flatness of the glass carrier layer 24, the flatness of the flexible glass substrate 26, and the adhesion quality that is required for the particular application.

The intermediate layer 50 can include several orientations and/or arrangements of the first debond layer 54 and the adhesive layer 58. As shown in the example glass structure 20a in FIG. 1, the glass carrier layer 24 can be attached to the first debond layer 54 and the flexible glass substrate 26 can be attached to the adhesion layer 58. As previously described, the first debond layer 54, together with the adhesion layer 58, form the intermediate layer 50 which at least temporarily bonds the flexible glass substrate 26 to the glass carrier layer 24.

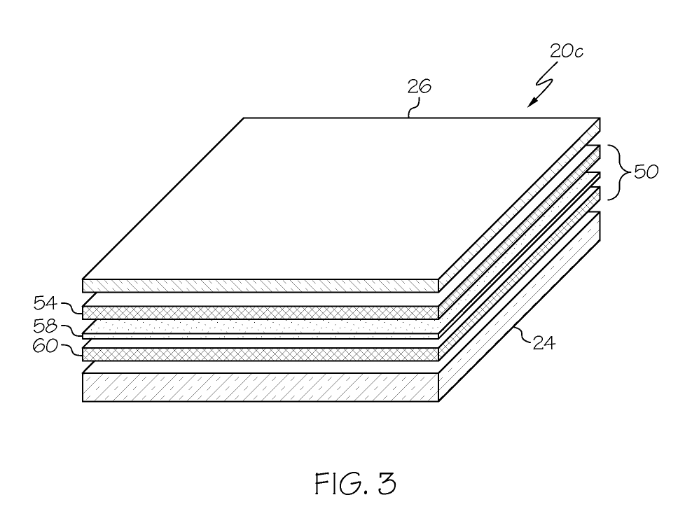

As shown in an example glass structure 20b in FIG. 2, the flexible glass substrate 26 is attached to the first debond layer 54 and the adhesion layer 58 is located between the glass carrier layer 24 and the first debond layer 54. In the example shown in FIG. 3, a glass structure 20c can be similar to the example shown in FIG. 2 while further including a second debond layer 60 located between the adhesion layer 58 and the glass carrier layer 24. As such, the glass structure 20c of this example includes (starting at the bottom of FIG. 3 and moving upward) the glass carrier layer 24, the second debond layer 60, the adhesion layer 58, the first debond layer 54, and the flexible glass substrate 26.

It is to be appreciated that FIGS. 1-3 each show gaps, or separation distances between each of the layers of the glass structure 20 (where the reference numeral 20 is intended to refer to any one of the illustrated glass structures 20a, 20b and/or 20c) for the purposes of clarity only. Each surface of each layer is in contact with the corresponding surface of the adjoining layer over substantially the entire surface. When at least temporarily bonded in the order shown in FIGS. 1-3, the glass carrier layer 24 provides support for the flexible glass substrate 26 to reduce and/or eliminate sag and other physical distortion of the flexible glass substrate 26 during handling and processing operations. As such, the relatively thin flexible glass substrate 26 included in the glass structures 20a-c can be handled and processed just as if it were a relatively thick glass substrate (e.g., 0.5 mm thickness and greater). This enables the use of existing glass handling and processing machinery for flexible glass substrates while reducing and/or eliminating operation down time from broken glass substrates. The glass carrier layer 24 by itself does not need to include the higher stiffness required for handling the flexible glass substrate 26 as a relatively thick glass substrate. Instead, the combination of the glass carrier layer 24, the intermediate layer 50, and the flexible glass substrate 26 bonded together as the glass structure 20 provide the requisite stiffness required to enable handling and processing as a relatively thick glass substrate.

FIG. 4 schematically illustrates a method of creating the glass structure 20a of FIG. 1 wherein similar or identical methods may be applied to create the glass structures 20b-c of FIGS. 2 and 3. The method includes the step 70 of providing a glass carrier layer 24. As discussed above, the glass carrier layer 24 is configured to add stiffness to a glass substrate when the two are bonded together in the glass structures 20a-c. In one example, the glass carrier layer 24 can have an average thickness within a range from about 300 microns to about 700 microns. In one example, the glass carrier layer 24 can have dimensions which correspond to sizes typically used in glass substrate display manufacturing.

The method further includes the step 74 of providing a flexible glass substrate 26. As discussed above, the flexible glass substrate 26 can include a relatively thin average thickness of less than about 300 microns. The average thickness of the flexible glass substrate 26 is typically determined by the desired display application. Additionally, it can be beneficial for the composition of the flexible glass substrate 26 to be compatible with the processing steps that create the desired display application using the glass structure 20. It can also be beneficial for the composition of the flexible glass substrate 26 to be similar to the composition of the glass carrier layer 24 so that the two glass components have the same or substantially similar coefficients of thermal expansion. In another example, the flexible glass substrate 26 can include dimensions equal to or less than the dimensions of the glass carrier layer 24.

The method further includes the step 76 of temporarily bonding the glass carrier layer 24 to the flexible glass substrate 26 with the intermediate layer 50 comprising the first debond layer 54 and the adhesion layer 58. Step 76 can further include the step 78 of applying the first debond layer 54 on a surface of at least one of the glass carrier layer 24 and the flexible glass substrate 26. In the example shown in FIG. 4, the first debond layer 54 is applied on the glass carrier layer 24 and temporarily bonds the glass carrier layer 24 with the first debond layer 54. In another example, although not shown, the first debond layer 54 is applied on the flexible glass substrate 26 and temporarily bonds the flexible glass substrate 26 with the first debond layer 54. In one particular example, the first debond layer 54 is applied as a solution-based formula, enabling a relatively thin first debond layer 54. Any suitable method of applying the first debond layer 54 can be used including, but not limited to, spin coating, spray coating, dip coating, and slot coating.

Characteristics of the first debond layer 54 enable it to be at least partially resistant to a high temperature processing of the glass structure 20. In one example, the high temperature processing occurs at a temperature of greater than or equal to about 500° C. Furthermore, the first debond layer 54 enables the glass carrier layer 24 to be debonded from the flexible glass substrate 26 after the high temperature processing of the glass substrate 26 as will be described below.

The step 76 of temporarily bonding the glass carrier layer 24 to the flexible glass substrate 26 can further include the step 80 of at least partially curing the first debond layer 54. Curing the first debond layer 54 can remove a quantity of organic compounds which can negatively affect subsequent processing of the glass structure 20. In some examples, a partial cure of the first debond layer 54 enables the first debond layer 54 to retain an amount of surface tack which can help bond the components making up the glass structure 20. Any suitable processes can be used to at least partially cure the first debond layer 54 including, but not limited to, exposing the first debond layer 54 to a vacuum, exposing the first debond layer 54 to elevated temperatures, a combination of these two processes, etc. In a further example, the step 78 of applying the first debond layer 54 on a surface of at least one of the glass carrier layer 24 and the flexible glass substrate 26 includes applying a chemical precursor to a polyimide. In this example, the method can further include the step of curing the first debond layer 54 to a polyimide layer which can also be represented schematically in FIG. 4 by step 80.

After the step 80 of at least partially curing the first debond layer 54, the step 76 of temporarily bonding the glass carrier layer 24 to the flexible glass substrate 26 can further include the step 84 of applying the adhesion layer 58 to a surface of the first debond layer 54. Similar to the first debond layer 54, the adhesion layer 58 can be applied as a solution-based formula, enabling a relatively thin adhesion layer 58 to be applied. Any suitable method of applying the adhesion layer 58 can be used including, but not limited to, spin coating, spray coating, dip coating, and slot coating.

As discussed above and shown in FIG. 3, at least one example of the glass structure 20 can include the first debond layer 54, the adhesion layer 58 and the second debond layer 60 located between the glass carrier layer 24 and the flexible glass substrate 26. In this example, step 76 of temporarily bonding the glass carrier layer 24 to the flexible glass substrate 26 can further include the step of applying the second debond layer 60 to the other of the glass carrier layer 24 and the flexible glass substrate 26. In yet another example, the step 76 of temporarily bonding the glass carrier layer 24 to the flexible glass substrate 26 can further include applying the adhesion layer 58 to the surface of the first debond layer 54 prior to the step of applying the second debond layer 60 to the other of the glass carrier layer 24 and the flexible glass substrate 26.

The example glass structure of FIG. 3 can provide increased strength of the bonding between the glass carrier layer 24 and the flexible glass substrate 26. This increased strength can be desirable, particularly for certain required processing conditions. Application of the debond layers 54, 60 directly onto the glass carrier layer 24 and the flexible glass substrate 26 rather than by contact via pressure can increase the strength of the bond. Additionally, the pliability of the adhesion layer 58 in this example can be more forgiving of imperfections in the flexible glass substrate 26.

Returning to FIG. 4, after the intermediate layer 50 including the first debond layer 54 and the adhesion layer 58 is suitably located, step 74 of providing a flexible glass substrate 26 can be carried out. Step 74 can include applying the flexible glass substrate 26 and any portion of the intermediate layer 50 that is bonded to the flexible glass substrate 26 to the glass carrier layer 24 and any portion of the intermediate layer 50 that is bonded to the glass carrier layer 24 to form the glass structure 20. The flexible glass substrate 26 can be applied to the glass carrier layer 24 by any suitable process including a roller lamination process.

In one particular example, an assembly process for a glass structure 20 can include the following steps. A polyimide or polyimide precursor such as PI-2574 is spun coat onto a glass carrier layer 24 to form the first debond layer 54. The glass carrier layer 24 and the first debond layer 54 are then exposed to at least a partial cure of the polyimide-containing first debond layer 54. The adhesion layer 58 may be provided by, for example, DOW CORNING 805 adhesive material is then spun-coat onto the exposed surface of the first debond layer 54. The glass carrier layer 24, the first debond layer 54, and the adhesion layer 58 can then be dried under a vacuum at room temperature for 30 minutes. This drying step can be a partial cure and can alternatively include an elevated temperature. The flexible glass substrate 26 may then be applied to form the glass structure 20, followed by an optional edge sealing step, if so desired. The glass structure 20 is then exposed to a full cure step.

In further examples, the glass structure can be formed in various orders by applying the layers to ultimately be bonded together in the final desired configuration. For example, referencing FIG. 1, the glass structure 20a can be provided by applying the adhesion layer 58 to the flexible glass substrate 26 and applying the first debond layer 54 to the glass carrier layer 24. Then the first debond layer 54 can be attached to the adhesion layer 58 such that the flexible glass substrate 26 is bonded to the glass carrier layer 24 to form the glass structure 20a. Likewise, with reference to FIG. 2, the glass structure 20b can be provided by applying the adhesion layer 58 to the glass carrier layer 24 and applying the first debond layer 54 to the flexible glass substrate 26. Then the first debond layer 54 can be attached to the adhesion layer 58 such that the flexible glass substrate 26 is bonded to the glass carrier layer 24 to form the glass structure 20b. Furthermore, with reference to FIG. 3, the glass structure 20c can be provided by applying the first debond layer 54 to the flexible glass substrate 26 and applying the second debond layer 60 to the glass carrier layer 24. Then the adhesion layer 58 can be used (e.g., by attaching to one or both of the first and second debond layer 54, 60) such that the flexible glass substrate 26 is bonded to the glass carrier layer 24 to form the glass structure 20c.

A method of processing the glass structure 20 includes the step 56 of processing the glass structure 20 through a high temperature process at a temperature of greater than or equal to about 500° C., such as from about 500° C. to about 600° C. In one example, the high temperature process includes attaching at least one electrical component 90 to the glass structure 20. Examples of the at least one electrical component 90 include, but are not limited to, aSi components, TFT components, transparent conductor components, and pSi TFT components. In one particular example, the application of the at least one electrical component 90 onto the flexible glass substrate 26 enables the combination to be utilized in a number of applications, such as touch sensors, color-filters, thin film transistors (TFT), photovoltaic (PV) glass applications.

After the at least one electrical component 90 is attached to the flexible glass substrate 26, the flexible glass substrate 26 can be removed from the glass structure 20 so that the flexible glass substrate 26 can be used as a glass display or electronic device. As such, the method of processing the glass structure 20 includes the step of de-bonding the flexible glass substrate 26 from the glass carrier layer 24. As previously described, the debond layers 54, 60 are configured to enable the flexible glass substrate 26 to be debonded from the glass carrier layer 24 after the high temperature processing 56 of the glass structure 20. As such, the debond layers 54, 60 can be exposed to the high temperature processing 56 while still retaining their bond strength and enabling the temporary bonds to be selectively debonded.

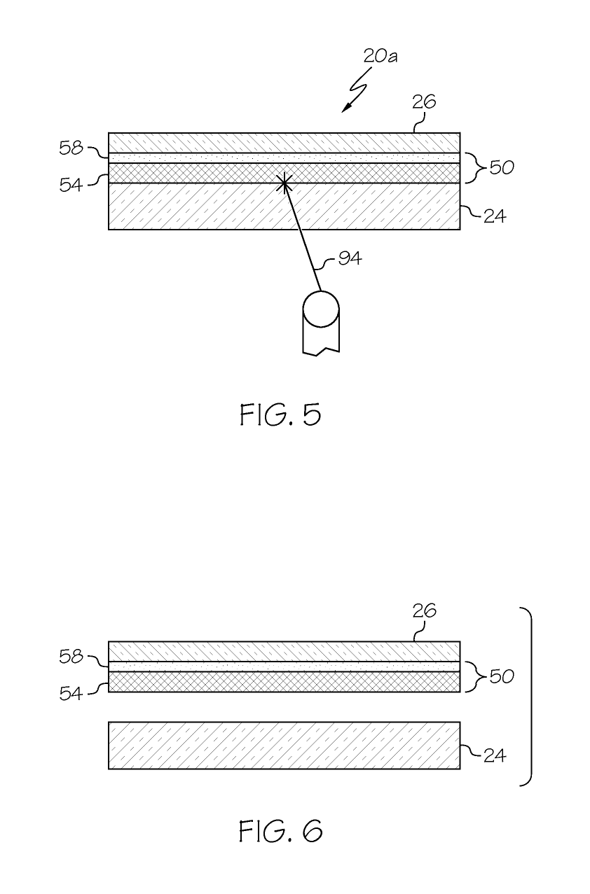

The step of debonding the flexible glass substrate 26 from the glass carrier layer 24 is illustrated in FIGS. 5-12. In one example, the step of debonding can be carried out with a laser process such as the Electronics on Plastic by Laser Release (EPLaR) process developed by Philips Research. In this step, a laser beam 94 can be directed through a portion of the glass structure 20a-c to apply energy to a surface of one of the debond layers 54, 60. The laser beam 94 can include light of a suitable, predetermined frequency such that the debond layers 54, 60 absorb the laser light causing the surface of the debond layer 54, 60 to ablate or heat and debond from the glass component 24, 26 to which it was bonded. The laser beam 94 can transmit through portions of the glass structure 20 which are transparent (e.g., substantially transparent) to the laser beam such that the laser beam 94 has no effect (e.g., no substantial effect) on the transparent structure and the laser beam can be transmitted through the transparent portion of the glass structure without losing a substantial amount of heat to the structure due to transmission through the transparent portion. For simplicity, FIGS. 5-12 do not show any electrical components 90 located on the top surfaces of the flexible glass substrate 26. However, these surfaces can also include attached electrical components 90 and/or electrical devices formed there. In further examples, other high intensity light sources may be used to debond, such as high-intensity ultraviolet light, visible or IR radiation or the like that may be designed to attack the bonding characteristic to achieve the desired debonding of the layers.

The laser beam 94 can be focused to include a particular area as it intersects with the surface of one of the debond layers 54, 60. Focus of the laser beam 94 can be adjusted to optimize the area of the surface of one of the debond layers 54, 60 that is ablated or heated, the time in which the area was ablated or heated, etc. The laser beam 94 can then be systematically moved from point to point along the surface of the debond layer 54, 60 so that, after a time, the entire surface of the debond layer 54, 60 has been ablated or heated and debonded from the glass component 24, 26 to which it was bonded. This process debonds the flexible glass substrate 26 from the glass carrier layer 24.

FIG. 5 shows one example of the step of debonding the flexible glass substrate 26 from a transparent glass carrier layer 24 of the glass structure 20a of FIG. 1. In this example, the intermediate layer 50 includes the first debond layer 54 and the adhesion layer 58 to temporarily bond the transparent glass carrier layer 24 to the flexible glass substrate 26. The first debond layer 54 is bonded to the transparent glass carrier layer 24. As shown, the laser beam 94 is passed through the transparent glass carrier layer 24 to ablate or heat a portion of the first debond layer 54 at the interface between the transparent glass carrier layer 24 and the first debond layer 54. After the laser systematically ablates or heats all or substantially all of the surface of the first debond layer 54, the flexible glass substrate 26 is debonded from the transparent glass carrier layer 24 and is removed from the glass structure 20a as shown in FIG. 6.

In some examples, such as the example of FIG. 6, after the step of debonding the flexible glass substrate 26 from the glass carrier layer 24 is complete, a portion of the intermediate layer 50 remains attached to the flexible glass substrate 26. In this particular example, both the first debond layer 54 and the adhesion layer 58 remain attached to the flexible glass substrate 26.

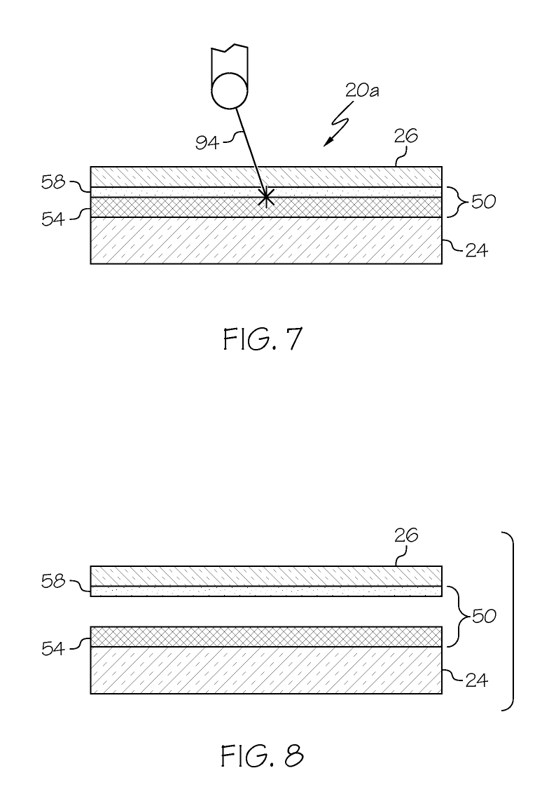

FIG. 7 shows another example of the step of debonding a transparent flexible glass substrate 26 from the glass carrier layer 24 of the glass structure 20a of FIG. 1. In this example, the intermediate layer 50 includes the first debond layer 54 and a transparent adhesion layer 58 to temporarily bond the glass carrier layer 24 to the transparent flexible glass substrate 26. The first debond layer 54 is bonded to the glass carrier layer 24. As shown, the laser beam 94 is passed through the transparent flexible glass substrate 26 and the transparent adhesion layer 58 to ablate a portion of the first debond layer 54 at the interface between the transparent adhesion layer 58 and the first debond layer 54. After the laser systematically ablates all or substantially all of the surface of the first debond layer 54, the flexible glass substrate 26 is debonded from the glass carrier layer 24 and is removed from the glass structure 20 as shown in FIG. 8. FIG. 8 shows the adhesion layer 58 remaining attached to the flexible glass substrate 26 and the first debond layer 54 remaining attached to the glass carrier layer 24.

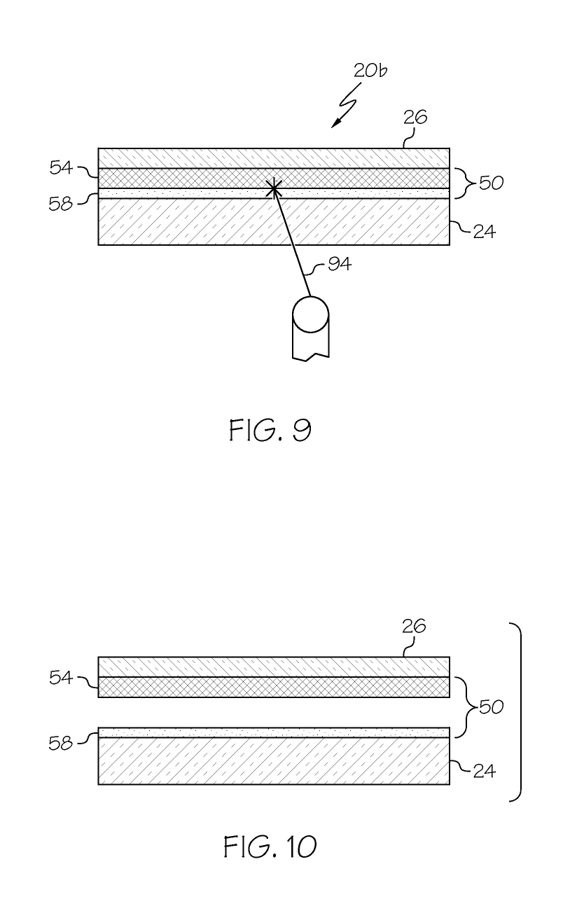

FIG. 9 shows an example of the step of debonding the flexible glass substrate 26 from a transparent glass carrier layer 24 of the glass structure 20b of FIG. 2. In this example, the intermediate layer 50 includes the first debond layer 54 and a transparent adhesion layer 58 to temporarily bond the glass carrier layer 24 to the flexible glass substrate 26. The first transparent debond layer 54 is bonded to the flexible glass substrate 26. As shown, the laser beam 94 is passed through the transparent glass carrier layer 24 and the transparent adhesion layer 58 to ablate a portion of the first debond layer 54 at the interface between the transparent adhesion layer 58 and the first debond layer 54. After the laser systematically ablates all or substantially all of the surface of the first debond layer 54, the flexible glass substrate 26 is debonded from the glass carrier layer 24 and is removed from the glass structure 20 as shown in FIG. 10. FIG. 10 shows the first debond layer 54 remaining attached to the flexible glass substrate 26 and the adhesion layer 58 remaining attached to the glass carrier layer 24.

As shown in FIGS. 6, 8, and 10, portions of the intermediate layer may remain attached to the flexible glass substrate. Indeed, as discussed above, portions of the adhesion layer 58 may remain attached to the flexible glass substrate 26 as shown in FIG. 8. In further examples, portions of the first debond layer 54 may remain attached to the flexible glass substrate 26 as shown in FIG. 10. Still further, as shown in FIG. 6, portions of both the adhesion layer 58 and the first debond layer 54 may remain attached to the flexible glass substrate 26. Having at least a portion of the intermediate layer 50 remaining attached to the flexible glass substrate 26 can be beneficial to the flexible glass substrate 26. In one example, the portion of the intermediate layer 50 can provide physical protection for the flexible glass substrate 26. In another example, allowing a portion of the intermediate layer 50 to remain attached to the flexible glass substrate 26 can be less costly to manufacture in comparison to a process that includes subsequent steps to completely remove the intermediate layer 50 from the flexible glass substrate 26. In some examples, the residual portions of the intermediate layer 50 may never need to be removed. For instance, the flexible glass substrate 26 may not be required to have optical clarity in the end product design, wherein the residual portions of the intermediate layer 50 do not impair the functionality of the product incorporating the flexible glass substrate 26.

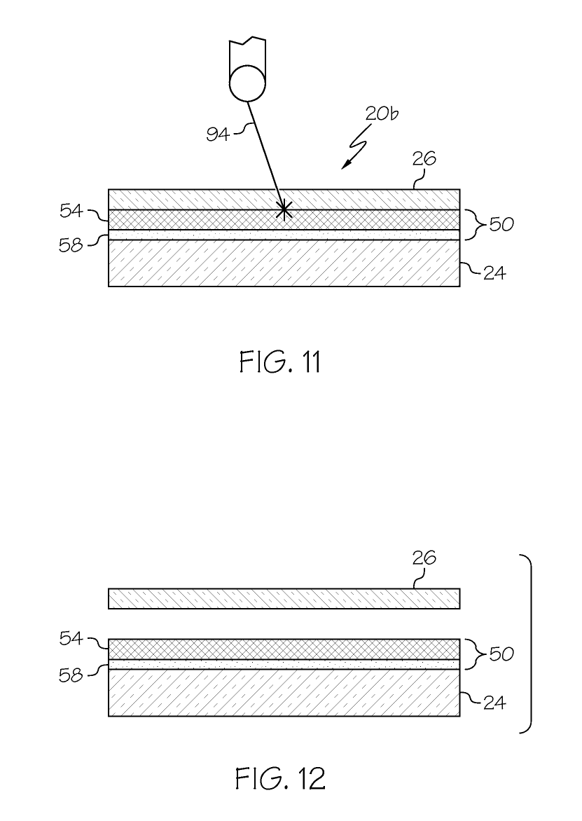

FIG. 11 shows another example of the step of debonding a transparent flexible glass substrate 26 from the glass carrier layer 24 of the glass structure 20b of FIG. 2. In this example, the intermediate layer 50 includes the first debond layer 54 and the adhesion layer 58 to temporarily bond the glass carrier layer 24 to the transparent flexible glass substrate 26. The first debond layer 54 is bonded to the transparent flexible glass substrate 26. As shown, the laser beam 94 is passed through the transparent flexible glass substrate 26 to ablate a portion of the first debond layer 54 at the interface between the transparent flexible glass substrate 26 and the first debond layer 54. In this example, the laser beam can be programmed to avoid intersecting any electrical components 90 and/or electrical devices formed on the top surface of the flexible glass substrate 26. After the laser systematically ablates all or substantially all of the surface of the first debond layer 54, the flexible glass substrate 26 is debonded from the glass carrier layer 24 and is removed from the glass structure 20 as shown in FIG. 12.

FIG. 12 shows the first debond layer 54 and the adhesion layer 58 remaining attached to the glass carrier layer 24. In this example, the flexible glass substrate 26 can be debonded and removed with little or any residue from the intermediate layer 50. Removing the flexible glass substrate 26 with little or any residue from the intermediate layer 50 can be beneficial in applications where optical performance characteristics of the flexible glass substrate 26 is important.

Referencing a portion of the glass structure (e.g., glass carrier layer 24, flexible glass substrate 26 and/or adhesion layer 58) as “transparent” in the discussion of FIGS. 5-12 means that the “transparent” portion of the glass structure is configured to permit passage of the laser beam 94 without a substantial amount of energy of the laser beam being lost by the act of being transmitted through the “transparent” portion. As such, it is possible that the portion of the glass structure may be optically translucent and/or act to visually obscure objects being viewed through that portion of the glass structure while still being transparent in the sense that a laser beam may pass through the “transparent” portion without a substantial amount of energy loss.

Aspects of the disclosure provide a process and apparatus which allow temporary bonding of a flexible glass substrate to a carrier layer using bonding materials that are resistant to high temperature processes during an electronic display manufacturing process and the flexible glass substrate can be debonded from the carrier layer after the high temperature process. Such techniques can avoid drawbacks of subsequent etching or polishing a processed relatively thick glass substrate to achieve the desired glass thickness. Indeed, techniques of the disclosure can avoid waste of materials and relatively time consuming and costly processes associated with etching or polishing. Moreover, techniques of the disclosure can allow increasing the structural integrity of an otherwise fragile, relatively flexible glass sheet and/or glass ribbon so that processing techniques and apparatus often limited to relatively thick glass sheets/glass ribbons, may be used without damaging the relatively flexible glass ribbon/glass sheet. Thus, handling of flexible glass substrates in a manufacturing process, for example the deposition of amorphous silicon (aSi) and polysilicon thin film transistor (pSi TFT) devices or other electronic devices on the flexible glass substrate, can become manageable with a reduced cost in accordance with aspects of the disclosure.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A glass structure comprising:
a glass carrier layer;
a flexible glass substrate; and
an intermediate layer at least temporarily bonding the flexible glass substrate to the glass carrier layer, wherein the intermediate layer includes a first debond layer attached to an adhesion layer,
wherein the first debond layer is at least partially resistant to a high temperature processing of the glass structure at a temperature of greater than or equal to about 500° C., and the first debond layer is configured to enable the flexible glass substrate to be debonded from the glass carrier layer after the high temperature processing of the glass structure.

2. The glass structure of claim 1, wherein the first debond layer comprises a polyimide.

3. The glass structure of claim 1, wherein an average thickness of the intermediate layer is less than about 20 microns.

4. The glass structure of claim 1, wherein the glass carrier layer is attached to the first debond layer and the flexible glass substrate is attached to the adhesion layer.

5. The glass structure of claim 1, wherein the flexible glass substrate is attached to the first debond layer and the adhesion layer is located between the glass carrier layer and the first debond layer.

6. The glass structure of claim 5, further comprising a second debond layer located between the adhesion layer and the glass carrier layer.

7. The glass structure of claim 1, wherein the flexible glass substrate includes an average thickness of less than about 300 microns.

8. The glass structure of claim 1, wherein an average thickness of the glass carrier layer is within a range of from about 300 microns to about 700 microns.

9. A method of creating a glass structure comprising the steps of:
(I) providing a glass carrier layer;
(II) providing a flexible glass substrate; and
(III) temporarily bonding the glass carrier layer to the flexible glass substrate with an intermediate layer comprising a first debond layer and an adhesion layer,
wherein the first debond layer is at least partially resistant to a high temperature processing of the glass structure at a temperature of greater than or equal to about 500° C., and the first debond layer enables the glass carrier layer to be debonded from the flexible glass substrate after the high temperature processing of the glass structure.

10. The method of claim 9, wherein step (III) further comprises the step of applying the first debond layer on a surface of at least one of the glass carrier layer and the flexible glass substrate.

11. The method of claim 10, wherein step (III) further includes at least partially curing the first debond layer.

12. The method of claim 11, wherein, after at least partially curing the first debond layer, step (III) further includes the step of applying the adhesion layer to a surface of the first debond layer.

13. The method of claim 12, wherein step (III) further includes the step of applying a second debond layer to the other of the glass carrier and the flexible glass substrate.

14. The method of claim 13, wherein step (III) includes applying the adhesion layer to the surface of the first debond layer prior to the step of applying the second debond layer to the other of the glass carrier layer and the flexible glass substrate.

15. The method of claim 9, further comprising the step of curing the first debond layer to a polyimide layer.

16. The method of claim 9, wherein step (III) temporarily bonds the glass carrier layer with the first debond layer.

17. The method of claim 9, wherein step (III) temporarily bonds the flexible glass substrate with the first debond layer.

18. A method of processing a glass structure comprising the steps of:
(I) providing a glass structure including a glass carrier layer, a flexible glass substrate, and an intermediate layer attaching the flexible glass substrate to the glass carrier layer, wherein the intermediate layer includes a first debond layer attached to an adhesion layer;
(II) processing the glass structure through a high temperature process at a temperature of greater than or equal to about 500° C.; and then
(III) de-bonding the flexible glass substrate from the glass carrier layer.

19. The method of claim 18, wherein the step (II) of processing the glass structure includes attaching at least one electrical component to the glass structure.

20. The method of processing a glass structure of claim 18, wherein after the step (III) of debonding the flexible glass substrate from the glass carrier layer, a portion of the intermediate layer remains attached to the flexible glass substrate.
